(19) United States
(12) Patent Application Publication
(10) Pub. No.: US 2013/0154781 A1
(43) Pub. Date: Jun. 20, 2013

(54) Windings and Formation Methods for Transformers

(71) Applicant: SHAMROCK MICRO DEVICES CORP., Taipei (TW)

(72) Inventor: Chien-Chen Cho, Kaohsiung City (TW)

(73) Assignee: SHAMROCK MICRO DEVICES CORP., Taipei (TW)

(21) Appl. No.: 13/633,303

(22) Filed: Oct. 2, 2012

(30) Foreign Application Priority Data
Dec. 14, 2011 (TW) 100146082

(51) Int. Cl. H01F 5/04; H01F 41/06

(52) U.S. Cl. CPC H01F 5/04; H01F 41/0612
USPC 336/180; 242/430

(57) ABSTRACT

Embodiments of the present invention pertain to windings and methods thereof. A disclosed winding is for an inductive device, having a winding core and a winding portion. The winding portion has a first winding layer, a connection section, and a second winding layer. The first winding layer comprises a first solenoid wound around the winding core along a step direction. The connection section is on the first winding layer, substantially in parallel to the step direction. The second winding layer comprises a second solenoid wound around the first winding layer along the step direction. The connection section electrically connects the first and second winding layers.

### CROSS-REFERENCE TO RELATED APPLICATION

This application claims priority to and the benefit of Taiwan Application Series Number 100146082 filed on Dec. 14, 2011, which is incorporated by reference in its entirety.

### BACKGROUND

The present disclosure relates generally to windings and the formation methods therefore, and more particularly, to windings suitable to be used in transformers.

Transformers are commonly adapted in electronic and electrical apparatuses. For example, transformers might boost or down-convert operation voltages, transfer electrical power from one stage to another, or perform impedance matching for a load. Transformers generally apply magnetic induction to transfer electrical power from one circuit to another circuit.

A transformer commonly has several windings, located in close proximity to make the magnetic field of a winding link to the magnetic field of another winding. One of the windings is referred to as a primary winding and another is referred to as a secondary winding. It is possible to increase or decrease the output voltage of a transformer by changing the turn ratio of the primary winding to the secondary winding. As known in the art, each winding has one or more solenoid to generate associated magnetic field.

FIG. 1 demonstrates winding 10 in the art. Enameled wire 12, a kind of conductive wire coated with a very thin insulating layer, winds around winding core 14 to form a solenoid, functioning as winding 10. Winding core 14 could be a winding shaft, inside which could be magnetic material.

FIGS. 2A to 2C are side views of winding 10 during different stages when forming winding 10. Please refer to FIG. 2A, where enameled wire 12 winds around winding core 14 circle-by-circle along step direction 16a from right to left, to form the most inner winding layer 18a. FIG. 2B illustrates how winding layer 18b is formed by winding enameled wire 12 around winding core 14 and winding layer 18a circle-by-circle along step direction 16b from left to right. Enameled wire 12 continues to wind around winding core 14 and winding layer 18b circle-by-circle along step direction 18c from right to left, forming winding layer 18c. It can be found from FIGS. 2A, 2B and 2C, that step directions 18a and 18c are the same, but opposite to step direction 18b.

### SUMMARY

Embodiments of the present invention disclose a winding for an inductive device. The winding has a winding core and a winding portion. The winding portion has a first winding layer, a connection section, and a second winding layer. The first winding layer comprises a first solenoid wound around the winding core along a step direction. The connection section is on the first winding layer, substantially in parallel to the step direction. The second winding layer comprises a second solenoid wound around the first winding layer along the step direction. The connection section electrically connects the first and second winding layers.

Embodiments of the present invention disclose a method for forming a winding in an inductive device. A conductive wire is first provided. The conductive wire winds, along a step direction, around a winding core to form a first solenoid. The conductive wire is extended along a direction parallel to the step direction, to form a connection section on the first solenoid. The conductive wire winds, along the step direction, around first solenoid and the connection section to form a second solenoid.

Embodiments of the present invention disclose a transformer with a winding core, a primary winding and a secondary winding. The primary winding has a first winding layer, a connection section, and a second winding layer. The first winding layer has a first solenoid wound around the winding core along a step direction. The connection section is on the first winding layer, substantially in parallel to the step direction. The second winding layer comprises a second solenoid wound around the first winding layer and the connection section along the step direction. The secondary winding comprises a secondary solenoid wound around the second solenoid.

### BRIEF DESCRIPTION OF THE DRAWINGS

The invention can be more fully understood by the subsequent detailed description and examples with references made to the accompanying drawings, wherein:

FIG. 1 demonstrates a winding in the art;

FIGS. 2A to 2C are side views of the winding of FIG. 1 during different stages when forming the winding;

FIGS. 3A-1 and 3A-2 illustrate side and perspective views of a winding, respectively, when a winding layer is formed;

FIGS. 3B-1 and 3B-2 illustrate side and perspective views of the winding, respectively, when a connection section is formed;

FIGS. 3C-1 and 3C-2 illustrate side and perspective views of the winding, respectively, when another winding layer is formed;

FIGS. 3D-1 and 3D-2 illustrate side and perspective views of the winding, respectively, when another connection section is formed;

FIGS. 3E-1 and 3E-2 illustrate side and perspective views of the winding, respectively, when another winding layer is formed;

FIG. 4A demonstrates the currents flowing in two winding layers in FIG. 2C, and the possibly-induced magnetic fields;

FIG. 4B shows correlation between two magnetic fields in FIG. 4A;

FIG. 5A demonstrates the currents flowing in two winding layers in FIG. 3E-1, and the possibly-induced magnetic fields;

FIG. 5B shows correlation between two magnetic fields in FIG. 5A; and

FIG. 6 demonstrates a transformer according to embodiments of the invention.

### DETAILED DESCRIPTION

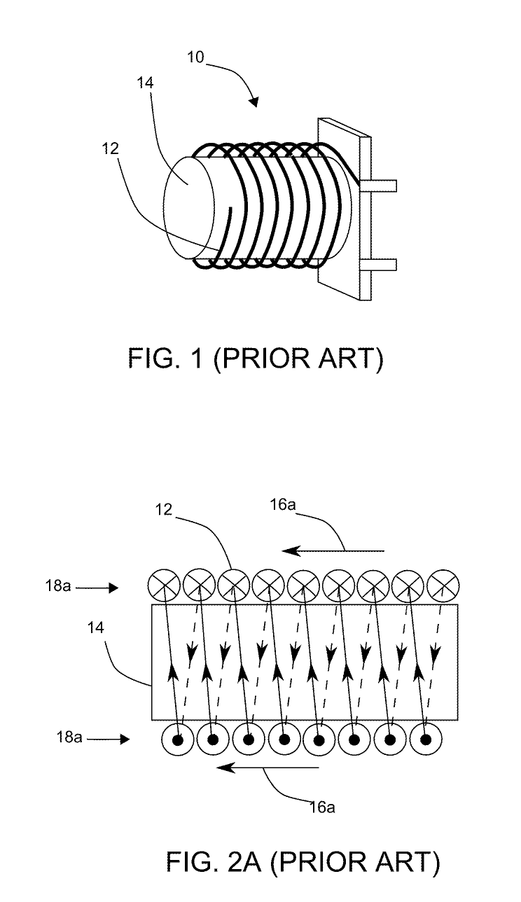

FIGS. 3A-1 and 3A-2 illustrate side and perspective views of winding 60, respectively, when winding layer 68a is formed. Starting from terminal 70 and ending at terminal 72, enameled wire 64 winds around winding core 62 circle-by-circle along step direction 66a from right to left. Each turn should be as close to a previous one as possible, to reduce induction leakage, if any. As shown in FIGS. 3A-1 and 3A-2, a solenoid with winding layer 68a is formed surrounding winding core 62, where terminals 70 and 72 seem to be starting and ending terminals of winding layer 68a, respectively.

FIGS. 3B-1 and 3B-2 illustrate side and perspective views of winding 60, respectively, when connection section 74 is formed. When winding layer 68a is completed, fastening object 76a, which is a piece of Mylar tape in one embodiment, is then used to substantially fasten the position of terminal 72. Enameled wire 64 is then bent and extended along a direction opposite to step direction 66a to form connection section 74. Fastening object 76b, which could be another piece of Mylar tape, substantially fastens the position of terminal 78, where enameled wire 64 is slightly bent to form another turning.

As shown in FIGS. 3B-1 and 3B-2, connection section 74 is substantially in parallel to the axis of the solenoid of winding layer 68a and crosses over most of the turns in winding layer 68a. In another embodiment, fastening objects 76a and 76b are two protruding portions of winding core 62 around which enameled wire 64 are bent and fixed, roughly defining the positions of terminals 72 and 78.

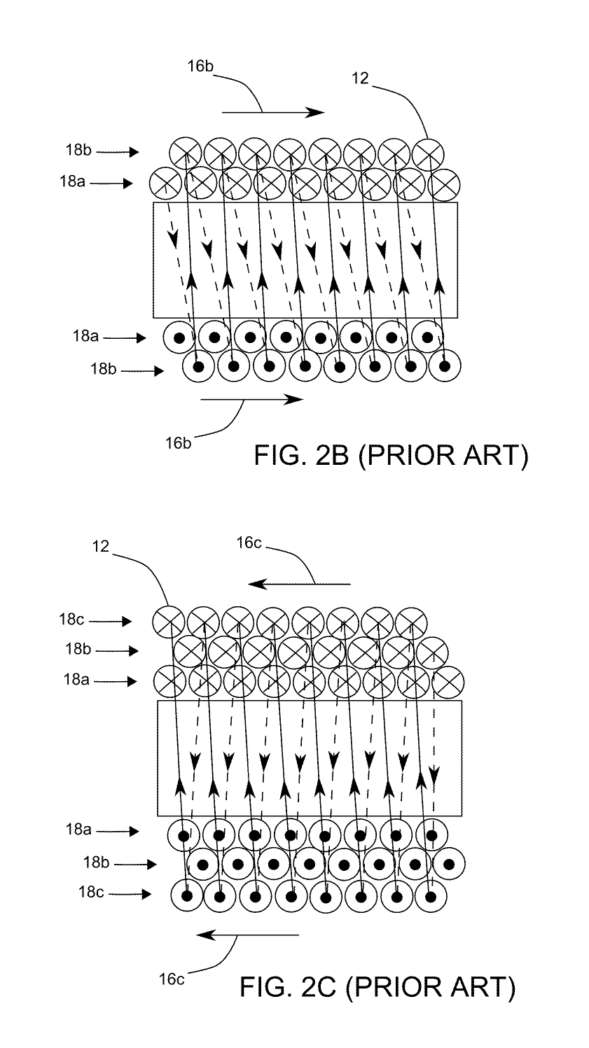

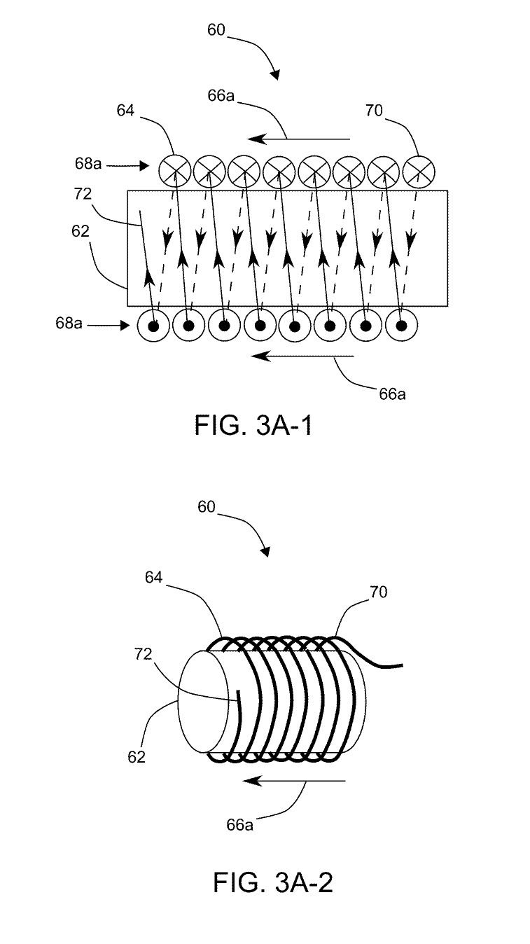

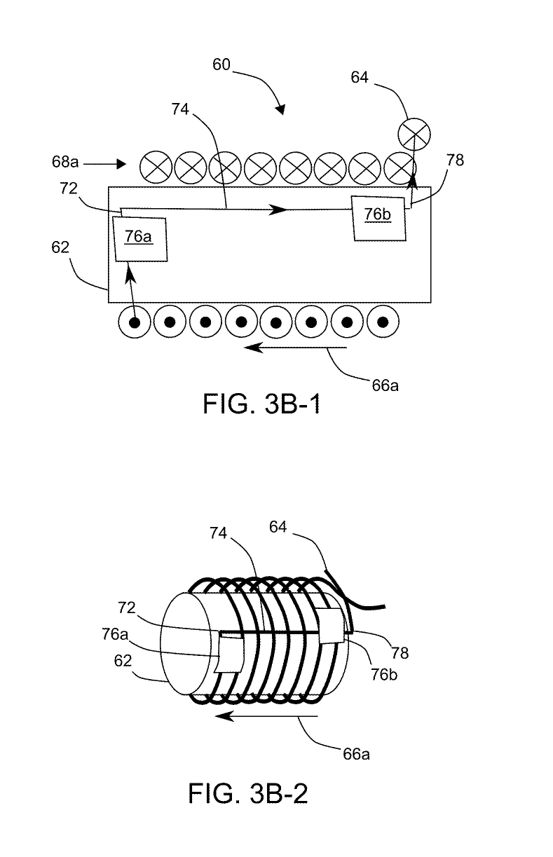

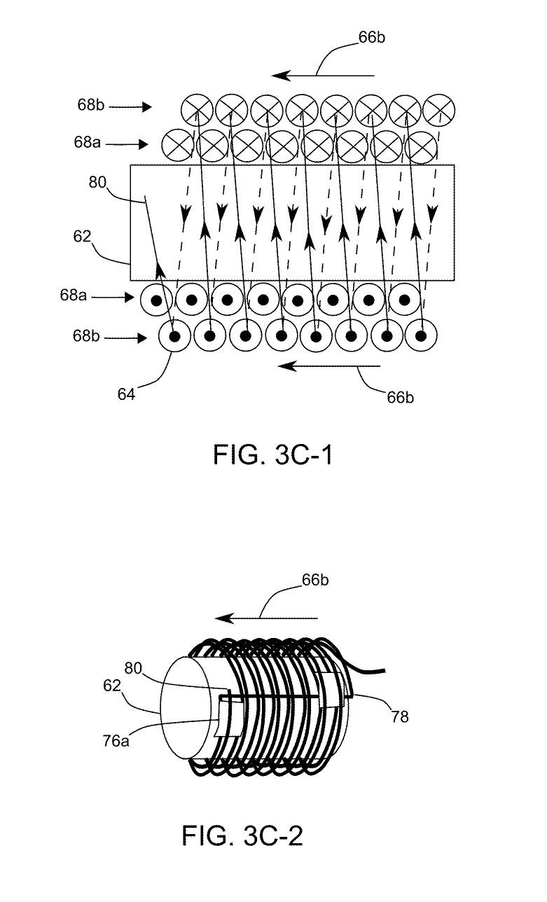

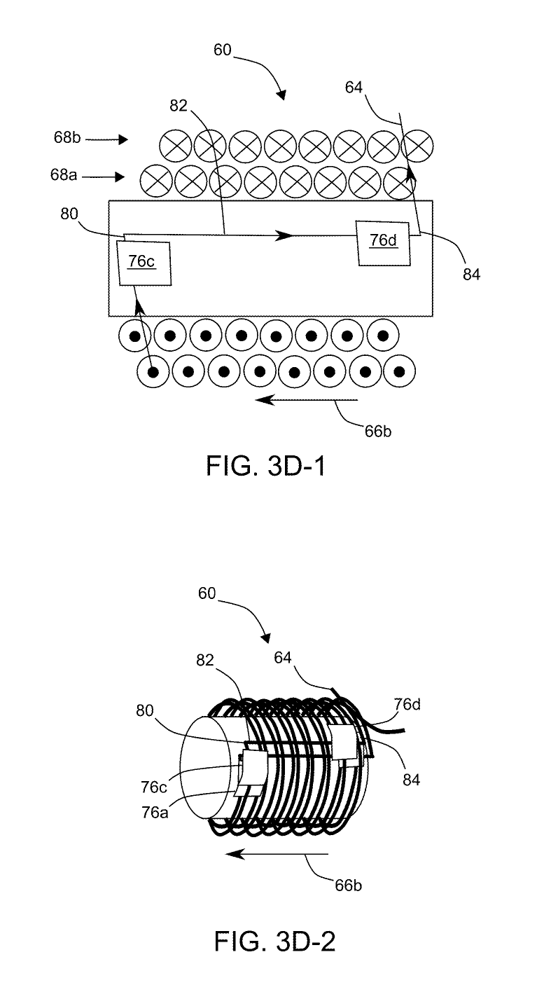

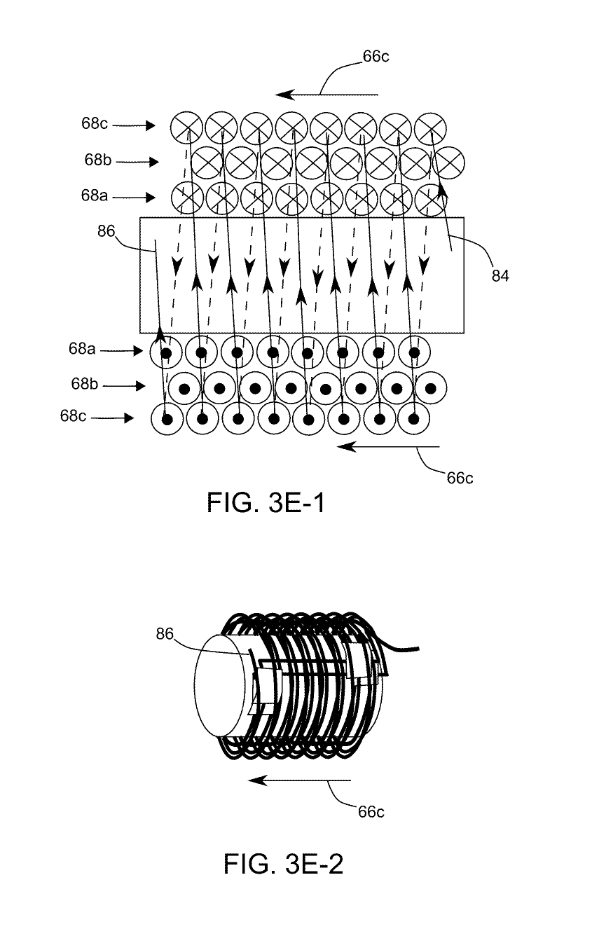

FIGS. 3C-1 and 3C-2 illustrate side and perspective views of winding 60, respectively, when winding layer 68b is formed. Similar to the formation of winding layer 68a, enameled wire 64, from terminal 78 and to terminal 80, winds around winding core 62 circle-by-circle along step direction 66b from right to left. Another solenoid with winding layer 68b is now formed around and over winding layer 68a. As shown in FIG. 3C-2, connection section 74 and fastening objects 76a, 76b as well are sandwiched between winding layers 68a and 68b. Terminals 78 and 80 seem to be a starting terminal and an ending terminal of winding layer 68b, respectively. Accordingly, connection section 74 electrically connects the ending terminal of winding layer 68a to the starting terminal of winding layer 68b. Step direction 66a is the same with step direction 66b, as can be derived from FIGS. 3B-1 and 3C-1. Each circle in winding layer 68b, as a result, is substantially in parallel to every circuit in winding layer 68a.

FIGS. 3D-1 and 3D-2 illustrate side and perspective views of winding 60, respectively, when connection section 82 is formed. Similar to the formation of connection section 74, connection section 82, electrically connecting terminals 80 and 84, is formed by extending enameled wire 64 along a direction opposite to step direction 66b, and fastened on winding layer 68b by fastening objects 76c and 76d. In one embodiment, connection sections 82 and 74 are on substantially the same location at the circumference of winding core 62, such that both form a stacked structure at one side of winding core 62. In another embodiment, connection sections 82 and 74 are on two different locations at the circumference of winding core 62. For example, winding core 62 is between connection sections 82 and 74.

FIGS. 3E-1 and 3E-2 illustrate side and perspective views of winding 60, respectively, when winding layer 68c is formed. Similar to the formation of winding layers 68a and 68b, enameled wire 64, from terminal 84 to terminal 86, winds around winding core 62 circle-by-circle along step direction 66c from right to left. Another solenoid with winding layer 68c is now formed over and around winding layer 68b and connection section 82. Because step directions 66a, 66b, and 66c are substantially all the same, each circle in winding layer 68c is substantially in parallel to every circuit in winding layer 68a or 68b.

In summary, if electric current flows into winding layer 68a through terminal 70, it spires toward to the left via winding layer 68a, goes back to the right through connection section 74 from terminal 72 to terminal 78, spires again toward to the left via winding layer 68b, goes back to the right through connection section 82 from terminal 80 to terminal 84, and so on.

Winding 60 of FIG. 3E-1 should induce a magnetic field with higher intensity than winding 10 of FIG. 2C does if they both have substantially the same size, the same number of turns, the same number of winding layers, and the same electric current flow.

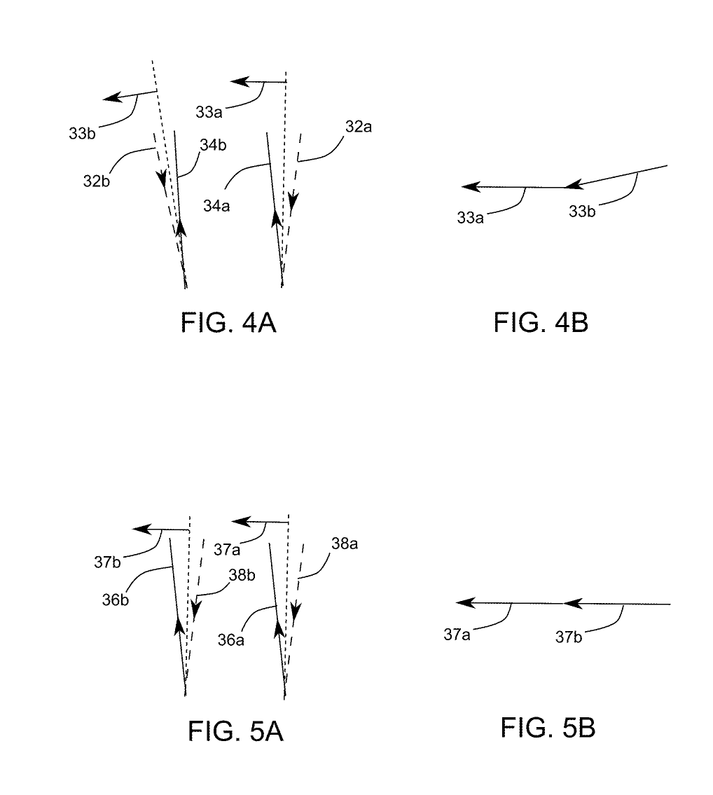

FIG. 4A demonstrates the currents flowing in winding layers 18a and 18b in FIG. 2C, and the possibly-induced magnetic fields, where solid line 34a with an arrow represents the current flowing through the front half of winding layer 18a, dashed line 32a with an arrow the current flowing through the rear half of winding layer 18a, and arrow 33a the magnetic field induced by winding layer 18a. The front half of winding layer 18 is substantially in front of winding core 14 and the rear half is behind winding core 14, in view of FIG. 2C. Similarly, solid line 34b and dashed line 32b, each having an arrow, represent the currents respectively flowing through the front and the rear halves of winding layer 18b, and arrow 33b represents the magnetic field induced by winding layer 18b. FIG. 4B shows correlation between magnetic fields 33a and 33b. As step directions 16a and 16b are in opposite, vectors of magnetic fields 33a and 33b will be slightly different in angle, and form a folded line if the end of one vector is attached to the beginning of the other, as shown in FIG. 4B.

FIG. 5A demonstrates the currents flowing in winding layers 68a and 68b in FIG. 3E-1, and the possibly-induced magnetic fields, where solid lines 36a and 36b with arrows represent the currents flowing through the front halves of winding layers 68a and 68b, dashed lines 38a and 38b with arrows the currents flowing through the rear halves of winding layers 68a and 68b, and arrows 37a and 37b the magnetic fields induced by winding layers 18a and 18b, respectively. FIG. 5B shows correlation between magnetic fields 37a and 37b. As step directions 66a and 66b are the same in direction, turns in winding layers 18a and 18b are almost in parallel to one another, such that magnetic field 37a shall have a direction the same with magnetic field 37b. A straight line may be formed if the end of the vector representing magnetic field 37b is attached to the beginning of the vector representing magnetic field 37a, as shown in FIG. 5B. If magnetic fields 33a and 37a have the same magnitude, and magnetic fields 33b and 37b do as well, the vector summation of magnetic fields 37a and 37b will be larger than the summation of magnetic fields 33a and 33b simply because magnetic fields 37a and 37b are in line to each other and magnetic fields 33a and 33b are not. Therefore, winding 60 of FIG. 3E-1 could induce an overall magnetic field with higher magnitude than winding 10 of FIG. 2C.

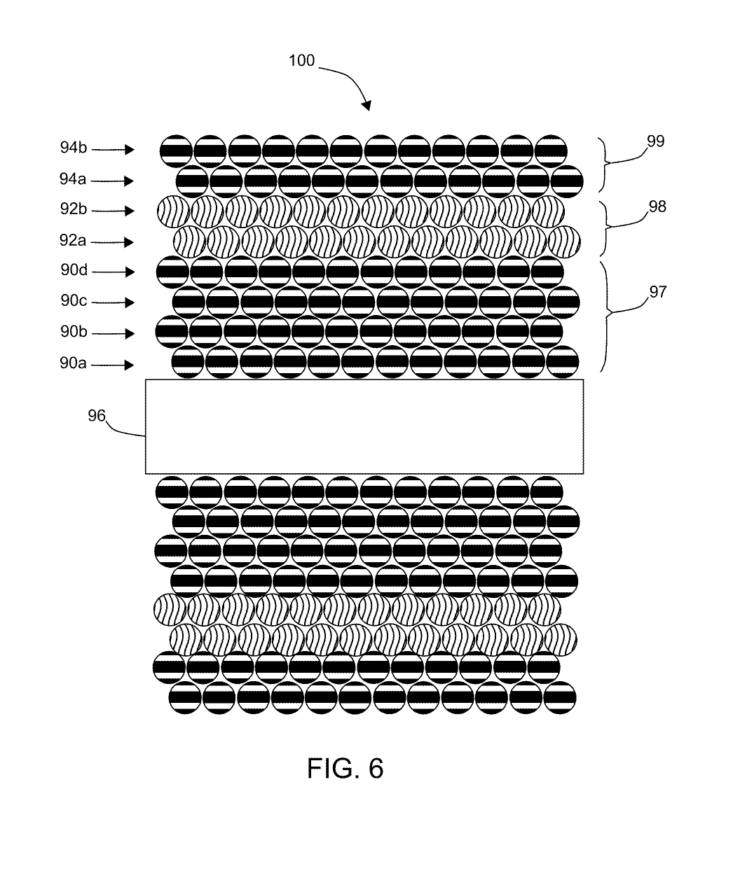

FIG. 6 demonstrates transformer 100 according to embodiments of the invention. In transformer 100 are winding core 96, a primary winding with inner portion 97 and outer portion 99, and secondary winding 98. Secondary winding 98 is located between inner portion 97 and outer portion 99. Inner portion 97 has winding layers 90a, 90b, 90c, and 90d; secondary winding 98 has winding layers 92a and 92b; and outer portion 99 has winding layers 94a and 94b. In one embodiment, similar with winding 60 of FIG. 3E-1, winding layers 90a, 90b, 90c, 90d, 94a and 94b in the primary winding all have the same step direction and the primary winding has connection sections (not shown), each connecting two neighboring winding layers, and sandwiched therebetween. For example, between winding layers 90a and 90b might exist a connection section (not shown) formed by extending an enameled wire along a direction opposite to the step direction commonly shared by winding layers 90a and 90b. It is preferred, but not limited, that both winding layers 92a and 92b of secondary winding 98 have the same step direction as the winding layers of the primary winding have. As analyzed, the primary winding in transformer 100 of FIG. 6 should induce a stronger magnetic field, in comparison with a conventional one.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A winding for an inductive device, comprising:
a winding core; and
a winding portion, comprising:
a first winding layer comprising a first solenoid wound around the winding core along a step direction;
a connection section on the first winding layer, substantially parallel to the step direction; and
a second winding layer comprising a second solenoid wound around the first winding layer along the step direction;
wherein the connection section electrically connects the first and second winding layers.

2. The winding as claimed in claim 1, wherein the connection section is sandwiched by the first and second winding layers.

3. The winding as claimed in claim 1, wherein the first solenoid has an ending terminal and the second solenoid has a starting terminal, the connection section connects the ending terminal to the starting terminal, and the winding further comprises two fastening objects for fastening the starting and ending terminals.

4. The winding as claimed in claim 3, wherein the fastening objects are pieces of Mylar tape.

5. The winding as claimed in claim 1, wherein the connection section is a first connection section, and the winding portion further comprises:
a second connection section on the second winding layer, substantially parallel to the step direction; and
a third winding layer comprising a third solenoid wound around the second winding layer along the step direction;
wherein the second connection section electrically connects the second and third winding layers.

6. The winding as claimed in claim 5, wherein the first and second connection sections are on substantially the same location at a circumference of the winding core.

7. The winding as claimed in claim 5, wherein the winding core is between the first and second connection sections.

8. A method for forming a winding, comprising:
providing a conductive wire;
winding, along a step direction, the conductive wire around a winding core to form a first solenoid;
extending the conductive wire along a direction parallel to the step direction to form a connection section on the first solenoid; and
winding, along the step direction, the conductive wire around the first solenoid and the connection section to form a second solenoid.

9. The method as claimed in claim 8, further comprising:
substantially fastening an ending terminal of the first solenoid; and
forming the connection section starting from the ending terminal.

10. The method as claimed in claim 8, further comprising:
fastening the conductive wire to form a starting terminal of the second solenoid; and
winding the conductive wire around the first solenoid and the connection section to form the second solenoid.

11. The method as claimed in claim 8, wherein the connection section is a first connection section, the method comprising:
extending the conductive wire along a direction parallel to the step direction to form a second connection section on the second solenoid; and
winding, along the step direction, the conductive wire around the second solenoid and the second connection section to form a third solenoid.

12. The method as claimed in claim 11, wherein the first and second connection sections are on substantially the same location at a circumference of the winding core.

13. The method as claimed in claim 11, wherein the winding core is between the first and second connection sections.

14. A transformer, comprising:
a winding core;
a primary winding, comprising:
a first winding layer comprising a first solenoid wound around the winding core along a step direction;
a connection section on the first winding layer, substantially parallel to the step direction; and
a second winding layer comprising a second solenoid wound around the first winding layer and the connection section along the step direction; and
a secondary winding, comprising a secondary solenoid wound around the second solenoid.

15. The transformer as claimed in claim 15, wherein primary winding further has a third solenoid wound around the secondary solenoid along the step direction.
